(19) United States
(12) Patent Application Publication
(10) Pub. No.: US 2017/0125786 A1
(43) Pub. Date: May 4, 2017

(54) BATTERY CELL

(71) Applicant: HYUNDAI MOTOR COMPANY, Seoul (KR)

(72) Inventors: Sang Mok PARK, Seongnam-si (KR); Sung Min CHOI, Gyeongju-si (KR)

(21) Appl. No.: 15/153,354

(22) Filed: May 12, 2016

(30) Foreign Application Priority Data
Nov. 4, 2015 (KR) 10-2015-0154791

(51) Int. Cl. H01M 2/34; H01M 2/26

(52) U.S. Cl. CPC H01M 2/348; H01M 2/26; H01M 2200/103

(57) ABSTRACT

A battery cell includes an electrode assembly, a pouch case accommodating the electrode assembly, and an electrode lead having an outer lead of which at least a portion outwardly protrudes from the pouch case and an inner lead connected to the electrode assembly and the outer lead, wherein the inner lead and the outer lead are connected by a coupling portion, and the coupling portion is fractured when the pouch case expands.

### CROSS-REFERENCE TO RELATED APPLICATION

This application claims the benefit of priority to Korean Patent Application No. 10-2015-0154791, filed on Nov. 4, 2015 with the Korean Intellectual Property Office, the disclosure of which is incorporated herein in its entirety by reference.

### TECHNICAL FIELD

The present disclosure relates to a battery cell, and more particularly, to a pouch type battery cell capable of interrupting a flow of current when overcharging occurs.

### BACKGROUND

As portable electric products such as video cameras, portable phones, and portable PCs have been increasingly used, an importance of a rechargeable battery used as a driving power source thereof has been increased.

In general, unlike a primary battery which is not charged, a rechargeable battery available to be charged and discharged has been actively researched in accordance with the development of high-tech fields such as digital cameras, cellular phones, laptop computers, power tools, electric bicycles, electric vehicles, hybrid vehicles and large-capacity power storage devices.

In particular, lithium-ion batteries, having a high energy density per unit weight and able to be rapidly charged compared with other secondary batteries such as existing lead storage batteries, nickel-cadmium batteries, nickel-hydrogen batteries, and nickel-zinc batteries, have been increasingly used.

A lithium-ion battery may have an operating voltage of 3.6V or higher and may be used as a power source of portable electronic devices, or a plurality of lithium-ion batteries may be connected in series or parallel to be used in high power electric vehicles, hybrid vehicles, power tools, electric bicycles, power storage devices and UPSs.

Compared with a nickel-cadmium battery or a nickel-metal hydride battery, a lithium-ion battery, having an operating voltage three times higher and excellent characteristics of energy density per specific weight, is commonly used.

A lithium-ion battery using a liquid electrolyte is generally welded and sealed in a circular or angular metal can as a container. Such a can-type rechargeable battery using a metal can as a container has a fixed shape, restricting a design of electronic products using the can-type rechargeable battery as a power source and causing a difficulty in reducing a volume of the can. Thus, a pouch-type rechargeable battery formed by packing an electrode assembly and an electrolyte in a pouch formed of a film and sealing the pouch has been developed and used.

However, a lithium-ion battery has a possibility of adverse effects when overheated, and thus, it is important to ensure safety.

A lithium-ion battery may be overheated due to various reasons. One of the reasons is a case in which an overcurrent greater than a limit value flows in the lithium-ion battery. When an overcurrent flows, the lithium-ion battery is heated due to Joule's heat, rapidly increasing an internal temperature thereof. Also, the rapid increase in the temperature causes a decomposition reaction of the electrolyte to cause thermal runaway, which may lead to an adverse effect of the battery. An overcurrent occurs when a sharp metal object penetrates through the lithium-ion battery, when insulation between a positive electrode and a negative electrode is fractured due to contraction of a separator interposed between the positive electrode and the negative electrode, or when a rush current is applied to the battery due to a fault in an externally connected charging circuit or a load.

Thus, in order to protect the lithium-ion battery from such an abnormal situation such as an occurrence of an overcurrent, the lithium-ion battery may be coupled with a protective circuit, and the protective circuit generally may have a fuse element irreversibly cutting a line in which a charge or discharge current flows when overcurrent occurs. However, in a case in which the fuse element malfunctions, internal pressure within the lithium-ion battery, that is, a battery cell, forming a battery module and/or a battery pack may continue to increase, leading to a possibility of an adverse event.

Thus, it is required to more reliably cut off a flow of a current to secure safety when internal pressure of a battery cell is increased.

### SUMMARY

The present disclosure has been made to solve the above-mentioned problems occurring in the prior art while advantages achieved by the prior art are maintained intact.

An aspect of the present disclosure provides an electrode lead capable of automatically interrupting a current applied to a battery cell when a fault (overcharge, overdischarge, or abnormally high temperature) occurs in the battery cell.

Another aspect of the present disclosure provides an electrode lead capable of mechanically operating to interrupt a current applied to a battery cell even without a separate power source or a controller.

Another aspect of the present disclosure is to reduce resistance by shortening a path in which a current flows, to the maximum.

The technical subjects of the present disclosure are not limited to the aforesaid, and any other technical subjects not described herein will be clearly understood by those skilled in the art from the embodiments to be described hereinafter.

According to an exemplary embodiment of the present disclosure, a battery cell may includes an electrode assembly; a pouch case accommodating the electrode assembly; and an electrode lead having an outer lead of which at least a portion outwardly protrudes from the pouch case and an inner lead connected to the electrode assembly and the outer lead, wherein the inner lead and the outer lead are connected by a coupling portion, and the coupling portion is fractured when the pouch case expands.

Details of embodiments are included in detailed descriptions and drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a plan view of a battery cell according to an exemplary embodiment of the present disclosure.

FIG. 2 is a cross-sectional view taken along line C-C of FIG. 1.

FIG. 3 is an exploded perspective view of an electrode terminal according to an exemplary embodiment of the present disclosure.

FIG. 4 is a cross-sectional view taken along line C-C of FIG. 1 when an electrode terminal is separated as a gas is generated within a battery cell.

### DETAILED DESCRIPTION

Advantages, features, and methods for achieving the advantages and features of the present application will become more readily apparent from the detailed description given hereinafter with reference to the accompanying drawings.

However, it should be understood that the detailed description and specific examples are given by way of illustration only, since various changes and modifications within the spirit and scope of the present disclosure will become apparent to those skilled in the art from this detailed description. Like reference numerals designate like elements throughout the specification.

Hereinafter, a battery cell according to an exemplary embodiment of the present disclosure will be described in detail with reference to the accompanying drawings.

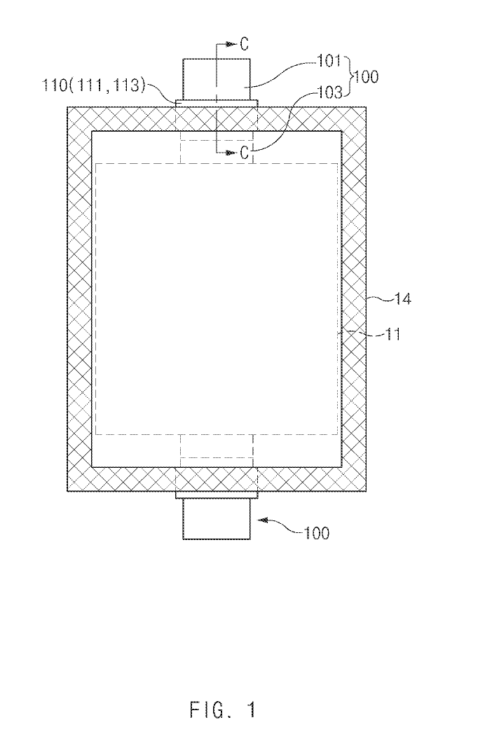

FIG. 1 is a plan view of a battery cell according to an exemplary embodiment of the present disclosure.

Referring to FIG. 1, a battery cell 10 may include an electrode assembly 11, a pair of electrode leads 100, a pouch adhesive layer 110 and a pouch case 14.

The electrode assembly 11 may include a positive electrode plate, a negative electrode plate, a separator, and an electrode tap. The electrode assembly 11 may be a stacked electrode assembly formed by interposing the separator between the stacked positive electrode plate and the negative electrode plate.

Also, the electrode assembly 11 may be formed as a jelly-roll type electrode assembly.

The positive electrode plate may be formed by coating a positive electrode active material on a current collector plate formed of aluminum (Al). The negative electrode plate may be formed by coating a negative electrode active material on a current collector plate formed of copper (Cu).

The electrode tap may be integrally formed with the positive electrode plate or the negative electrode plate and may correspond to an uncoated region of the positive electrode plate or the negative electrode plate in which an electrode active material is not coated. That is, the electrode tap may include a positive electrode tap corresponding to a region of the positive electrode plate on which a positive electrode active material is not coated, and a negative electrode tap corresponding to a region of the negative electrode plate on which a negative electrode active material is not coated.

The electrode lead 100, a thin plate-like metal, may be attached to the electrode tap and extend in an outward direction of the electrode assembly 11. The electrode lead 100 may include a positive electrode lead attached to the positive electrode tap and a negative electrode lead attached to the negative electrode tap. The positive electrode lead and the negative electrode lead may extend in the same direction or in opposite directions according to formation positions of the positive electrode tap and the negative electrode tap.

The electrode lead 100 may serve to electrically connect an interior and an exterior of the battery cell 10, may be formed of a metal having electrical conductivity such as copper, nickel, or aluminum, and may have a plated layer to prevent corrosion.

The pouch adhesive layer 110 may be attached to the circumference of the electrode lead 100 in a width direction and interposed between the electrode lead 100 and an inner surface of the pouch case 14. The pouch adhesive layer 110 may be formed of a film having electrical insulation properties and thermal bondability. The pouch adhesive layer 110 may be formed of one or more material layers (single film or multi-film) selected from among polyimide (PI), polypropylene (PP), polyethylene (PE) and polyethylene terephthalate (PET), for example.

The pouch adhesive layer 110 may prevent an occurrence of a short circuit between the electrode lead 100 and a metal layer of the pouch case 14. Also, the pouch adhesive layer 110 may serve to enhance sealing power of the pouch case 14 in a region in which the electrode lead 100 is led out.

That is, in a case in which the electrode lead 100 formed of a metal and an inner surface of the pouch case 14 are not properly adhered, sealing characteristics in the region in which the electrode lead 100 is led out may be degraded even though edge regions of the pouch case 14 are thermally bonded to be sealed. In addition, the degradation of sealing characteristics may be severe when the surface of the electrode lead 100 is coated with nickel (Ni).

Thus, sealing characteristics of the battery cell 10 may be enhanced by interposing the pouch adhesive layer 110 between the electrode lead 100 and the pouch case 14.

The pouch case 14 may have an upper case 14a and a lower case 14b, and in particular, the pouch case 14 may be sealed as the edge regions thereof in which the upper case 14a and the lower case 14b are in contact with each other are thermally bonded with the electrode assembly 11 accommodated therein such that the electrode lead 100 is led out to the outside.

The pouch case 14 may have a multilayer structure in order to secure rigidity and insulating properties to maintain excellent thermal bondability and shape and protect the electrode assembly 11. For example, the pouch case 14 may have a multilayer structure including a first layer positioned on the innermost side to face the electrode assembly 11, a second layer positioned on the outermost side and directly exposed to an external environment and a third layer interposed between the first layer and the second layer.

In this case, for example, the first layer may be formed of a material having corrosion resistance, electrical insulation properties, and thermal bondability with respect to an electrolyte such as polypropylene (PP), the second layer may be formed of a material having rigidity and electrical insulation properties in order to maintain a shape such as polyethylene terephthalate (PET) and the third layer may be formed of a metal such as aluminum (Al).

In an abnormal situation in which a short-circuit occurs in the battery cell 10 or the battery cell 10 is overcharged, a gas may be generated within the cell. Here, the pouch case 14 may expand due to the gas, and if the abnormal situation is not resolved, the pouch case 14 may suffer an adverse event.

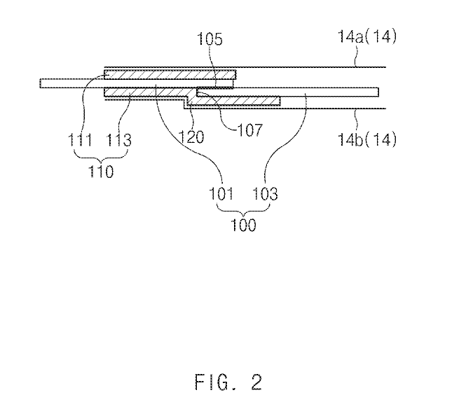

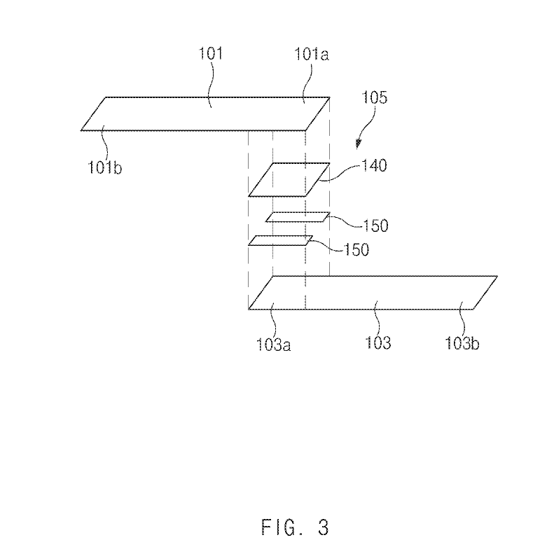

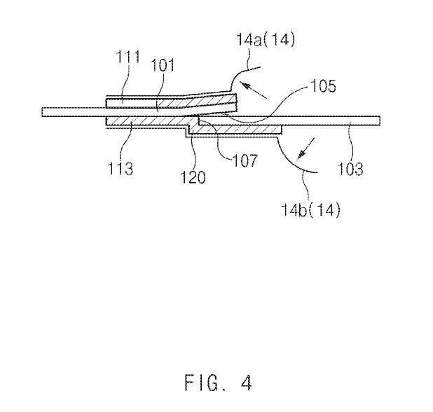

FIG. 2 is a cross-sectional view taken along line C-C of FIG. 1. FIG. 3 is an exploded perspective view of an electrode terminal according to an exemplary embodiment of the present disclosure. FIG. 4 is a cross-sectional view taken along line C-C of FIG. 1 when an electrode terminal is separated as a gas is generated within a battery cell.

Referring to FIGS. 2 and 3, according to various exemplary embodiments of the present disclosure, the electrode lead 100 may include an outer lead 101, of which at least a portion protrudes outwardly from the pouch case 14 and an inner lead 103 connected to the outer lead 101 and the electrode assembly 11.

One end 101b of the outer lead 101 may protrude outwardly from the pouch case 14, and the other end 101a of the outer lead 101 may be coupled to the other end 103a of the inner lead 103 within the pouch case 14 through welding.

The inner lead 103 may be positioned within the pouch case 14, one end 103b of the inner lead 103 may be connected to the electrode assembly 11 within the pouch case 14, and the other end 103a of the inner lead 103 may be coupled to the other end 101a of the outer lead 101 through welding.

That is, a coupling portion 105 may be formed as the other end 101a of the outer lead 101 and the other end 103a of the inner lead 103 are coupled through welding, and the outer lead 101 and the inner lead 103 may be electrically and physically connected by the coupling portion 105.

The coupling portion 105 may be configured to be easily fractured when the pouch case 14 expands internally in a case in which a short-circuit or a fault (overcharge, overdischarge, or abnormally high temperature) occurs in the battery cell 10. As the coupling portion 105 is fractured (see FIG. 4), the outer lead 101 and the inner lead 103 may be separated to interrupt a current, securing safety.

The other end 103a of the inner lead 103 and the other end 101a of the outer lead 101 may be coupled in a step structure, forming a step portion 107. Accordingly, when the battery cell 10 expands, the coupling portion 105 may be easily fractured.

According to various exemplary embodiments of the present disclosure, the coupling portion 105 may have a ‘partial welding’ structure in which the other end 101a of the outer lead 101 and the other end 103a of the inner lead 103 may be partially welded through spot welding or projection welding. For the purpose of the partial welding, projections having various shapes may be provided on the other end 101a of the outer lead 101 or on the other end 103a of the inner lead 103, whereby the welding structure may be variously adjusted. In this manner, since the coupling portion 105 has the partial welding structure, appropriate fracture pressure of the coupling portion 105 may be provided.

The pouch adhesive layer 110 may include an upper adhesive layer 111 disposed above the electrode lead 100 and a lower adhesive layer 113 disposed below the electrode lead 100.

The upper adhesive layer 111 may be interposed between an upper surface of the electrode lead 100 and the upper case 14a, and the lower adhesive layer 113 may be interposed between a lower surface of the electrode lead 100 and the lower case 14b.

A distance between the upper adhesive layer 111 and the electrode assembly 11 and a distance between the lower adhesive layer 113 and the electrode assembly 11 may be different, and the difference in the distance between the upper adhesive layer 111 and the lower adhesive layer 113 may further accelerate fracture occurring in the coupling portion 105.

The upper adhesive layer 111 and the lower adhesive layer 113 may seal the pouch case 14 to block inflow of ambient air.

The lower adhesive layer 113 may have a step bonding portion 120 formed to be stepped to correspond to the step portion 107 of the inner lead 103 and the outer lead 101.

According to various exemplary embodiments of the present disclosure, the coupling portion 105 may further include a bonding member 140 interposed between the other end 101a of the outer lead 101 and the other end 103a of the inner lead 103.

The bonding member 140 may be interposed between the other end 103a of the inner lead 103 and the other end 101a of the outer lead 101 to perform compression. The bonding member 140 may maximize a contact area between the inner lead 103 and the outer lead 101 to minimize electrical resistance. Also, the bonding member 140 may serve to adjust fracture pressure of the coupling portion 105, and may be mainly formed of gold, aluminum or copper having low electrical resistance and ductility.

According to an exemplary embodiment, the bonding member 140 is formed of a metal foil having low electrical resistance and ductility. The metal foil may maximize a contact area between electrical conductors to minimize electrical resistance.

Also, the bonding member 140 may be formed of an alloy material having a low melting point such as a tin-based alloy, or the like, to support a function of increasing operability when a temperature of the battery cell is increased.

The bonding member 140 may be formed of a material having a melting point lower than that of the electrode lead 100.

The coupling portion 105 may further include at least one of protective layer 150 protecting the coupling portion 105 from external forces that are unintended during manufacturing a component or the cell. Referring to FIGS. 3, two protective layers 150 may be interposed between the other end 101a of the outer lead 101 and the other end 103a of the inner lead 103.

The protective layer 150 may be formed of a polymer such as PP, PE, PET or Teflon. Thus, the protective layer 150 may prevent penetration of an electrolyte remaining within the cell to an interior of the coupling portion 105, thus preventing corrosion of the coupling portion 105.

The present disclosure has the following advantages.

First, the electrode lead automatically interrupting a current applied to the battery cell when a fault (overcharge, overdischarge, or abnormally high temperature) occurs in the battery cell is provided.

Second, the electrode lead is mechanically operated to interrupt a current applied to the battery cell even without a separate power source or a controller.

Third, a path in which current flows is shortened to the maximum, reducing resistance.

Effects of the present disclosure that may be obtained in the present disclosure are not limited to the foregoing effects and any other technical effects not mentioned herein may be easily understood by a person skilled in the art from the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A battery cell comprising:
an electrode assembly;
a pouch case accommodating the electrode assembly; and
an electrode lead having an outer lead of which at least a portion outwardly protrudes from the pouch case and an inner lead connected to the electrode assembly and the outer lead,
wherein the inner lead and the outer lead are connected by a coupling portion, and the coupling portion is fractured when the pouch case expands.

2. The battery cell according to claim 1, wherein one end of the outer lead protrudes outwardly from the pouch case, one end of the inner lead is connected to the electrode assembly, and
an other end of the outer lead and an other end of the inner lead are coupled through welding to form the coupling portion.

3. The battery cell according to claim 2, wherein the other end of the inner lead and the other end of the outer lead are coupled in a step structure.

4. The battery cell according to claim 3, wherein a pouch adhesive layer is provided to attach the electrode lead to the pouch case.

5. The battery cell according to claim 4, wherein the pouch adhesive layer includes an upper adhesive layer disposed above the electrode lead and a lower adhesive layer disposed below the electrode lead, and
a distance between the upper adhesive layer and the electrode assembly and a distance between the lower adhesive layer and the electrode assembly are different.

6. The battery cell according to claim 2, wherein the coupling portion further includes a bonding member interposed between the inner lead and the outer lead.

7. The battery cell according to claim 6, wherein the bonding member is formed of a metal foil having low electrical resistance and ductility.

8. The battery cell according to claim 6, wherein the bonding member is formed of a material having a melting point lower than that of the electrode lead.

9. The battery cell according to claim 2, further comprising a protective layer protecting the coupling portion.

10. The battery cell according to claim 9, wherein the protective layer is formed of a polymer material.
